(19) United States
(12) Patent Application Publication
(10) Pub. No.: US 2014/0032254 A1
(43) Pub. Date: Jan. 30, 2014

(54) Allocation of Agents in a Support Center to Meet Service Levels of Support Requests

(71) Applicant: INTERNATIONAL BUSINESS MACHINES CORPORATION, Armonk, NY (US)

(72) Inventors: Gianluca Della Corte, Rome (IT); Alessandro Donatelli, Rome (IT); Antonio M. Sgro, Rome (IT)

(21) Appl. No.: 13/911,661

(22) Filed: Jun. 6, 2013

(30) Foreign Application Priority Data
Jul. 26, 2012 (GB) 1213292.4

(51) Int. Cl. G06Q 30/00

(52) U.S. Cl. CPC G06Q 30/016
USPC 705/7.14

(57) ABSTRACT

A solution for controlling a support center providing support in respect of a set of products is provided. A set of support requests are received each support request in the set of support requests for at least one of the set of products. For each support request: a service level is associated with the support request according to service level information of the corresponding user stored in the data processing system, a list of candidate agents is determined adapted to serve the support request among a plurality of agents according to characteristic information of the agents; a selected agent is selected for the support request among the candidate agents, the selected agent being adapted to meet the service level of the support request with the lowest reputation indicated by the reputation indicator of the agent; and the support request is allocated to the corresponding selected agent.

### BACKGROUND

The solution according to one or more embodiments of the present invention relates to the data processing field. More specifically, this solution relates to the management of support centers.

Support center are commonly used to provide support in respect of one or more products (for example, software programs) to corresponding users. A typical example is a help-desk, which is used by users of the products to receive support in respect thereto remotely. For this purpose, the users may call a toll-free number of the support center to submit a support request for any issues relating to these products (for example, when they experience problems with their use); the support request is captured by the support center with the opening of a corresponding ticket. The tickets are allocated to agents of the support center (for example, software engineers), which serve them addressing the corresponding issues (for example, trying to solve the corresponding problems).

A problem of any known support center is the allocations of the tickets to its agents. The simplest technique for tackling this problem is of putting the tickets into a FIFO queue and serving them according to their order of arrival. However, this technique may cause very long waiting times, which may be unacceptable in specific situations (for example, for critical issues). For this reason, it is commonplace to assign a priority to each ticket so as to serve it accordingly (thereby giving precedence to the critical issues); however, this may lengthen the waiting time of the other tickets unreasonably (up to reach their starvation).

Therefore, standard scheduling techniques are used in an attempt to optimize the allocation of the tickets to the agents.

Conventionally, the allocation of the tickets is performed manually by one or more supervisors of the support center that allocate each new ticket to an available agent that is deemed the best one for serving it; however, this technique is strongly dependent on the skill of the supervisors and it is prone to human errors. Moreover, a rating of the agents (for their allocation) is only based on the knowledge thereof by the supervisors; therefore, this rating is very inaccurate and in any case mainly based on subjective impressions. Automatic reputation systems are instead known for ranking participants in online activities, such as online market places—for example, as described in US-A-2007/0192169 (the entire disclosure of which is herein incorporated by reference); however, these reputation systems address aspects completely different, so that they cannot be applied for rating the agents of the support center.

Automatic schedulers may also be used to provide more repeatable results. For example, as described in “AUCTION BASED MODELS FOR TICKET ALLOCATION PROBLEM IN IT SERVICE DELIVERY INDUSTRY, Prasad M Deshpande et al., 2008 IEEE International Conference on Services Computing” (the entire disclosure of which is herein incorporated by reference), a current industry practice is based on algorithms for the online scheduling problem on unrelated machines; this document instead proposes a different algorithm wherein the agents bid for the tickets and the tickets are assigned thereto depending on their bid values. Moreover, “Generative Models for Ticket Resolution in Expert Networks, Gengxin Miao et al, KDD'10, Jul. 25-28, 2010, Washington, D.C., USA” (the entire disclosure of which is herein incorporated by reference) proposes a probabilistic algorithm to generate ticket routing recommendations for new tickets in a network of agents. U.S. Pat. No. 7,366,731 (the entire disclosure of which is herein incorporated by reference) instead describes a trouble ticket handling system wherein a login logic operates to log each user into several trouble ticket systems. U.S. Pat. No. 8,028,197 (the entire disclosure of which is herein incorporated by reference) describes a method for facilitating the resolution of the tickets according to historical information. US-A-2007/0116185 (the entire disclosure of which is herein incorporated by reference) proposes assigning each new ticket to a group, and then directing the ticket to a specialist of the type of problems of its group. US-A-2007/0133781 (the entire disclosure of which is herein incorporated by reference) proposes calculating a current workload of each agent (according to the tickets allocated thereto and possibly further according to his/her productivity, competence and location); the agent to be allocated to each new ticket is then selected according to its priority and to the workload of the agents.

The problem of allocating the tickets to the agents is exacerbated by the fact that very often the tickets should be served meeting a pre-defined service level. Typically, the required service level is defined in a Service Level Agreement (SLA) that has been negotiated between the corresponding user and the support center (for example, as a maximum time for solving each problem). In this respect, US-A-2005/0261933 (the entire disclosure of which is herein incorporated by reference) discloses a technique for automatically applying an SLA to each ticket in an outsourced support center according to matching attributes thereof.

However, the techniques known in the art for allocating the tickets to the agent are very incomplete and imprecise for meeting the required service levels; therefore, they are inherently inefficient in this respect.

### SUMMARY

In its general terms, the solution according to one or more embodiments of the present invention is based on the idea of allocating the tickets to the agents according to the corresponding service levels to be met.

Particularly, one or more aspects of the solution according to specific embodiments of the invention are set out in the independent claims and advantageous features of the same solution are set out in the dependent claims, with the wording of all the claims that is herein incorporated verbatim by reference (with any advantageous feature provided with reference to a specific aspect of the solution according to the an embodiment of the invention that applies mutatis mutandis to every other aspect thereof).

More specifically, an aspect of the solution according to the an embodiment of the invention provides a method for controlling a support center; for each support request, an agent is selected to serve the support request from a list of candidate agents adapted for this purpose (which candidate agents are ordered according to a reputation indicator thereof calculated from corresponding characteristic information), with the selected agent that is adapted to meet a service level of the user of the support request with the lowest reputation.

Another aspect of the solution according to an embodiment of the invention provides a computer program for performing this method.

Another aspect of the solution according to an embodiment of the invention provides a corresponding system.

### BRIEF DESCRIPTION OF THE SEVERAL VIEWS OF THE DRAWINGS

The solution according to one or more embodiments of the invention, as well as further features and the advantages thereof, will be best understood with reference to the following detailed description, given purely by way of a non-restrictive indication, to be read in conjunction with the accompanying drawings (wherein, for the sake of simplicity, corresponding elements are denoted with equal or similar references and their explanation is not repeated, and the name of each entity is generally used to denote both its type and its attributes—such as value, content and representation). Particularly:

FIG. 1 shows an illustrative representation of an infrastructure wherein the solution according to the an embodiment of the invention may be applied,

FIG. 2 show an example of application of the solution according to the an embodiment of the invention,

FIG. 3 shows the main software modules that may be used to implement the solution according to the an embodiment of the invention, and

FIG. 4A-FIG. 4B show an activity diagram describing the flow of activities relating to an implementation of the solution according to the embodiment of the invention.

### DETAILED DESCRIPTION

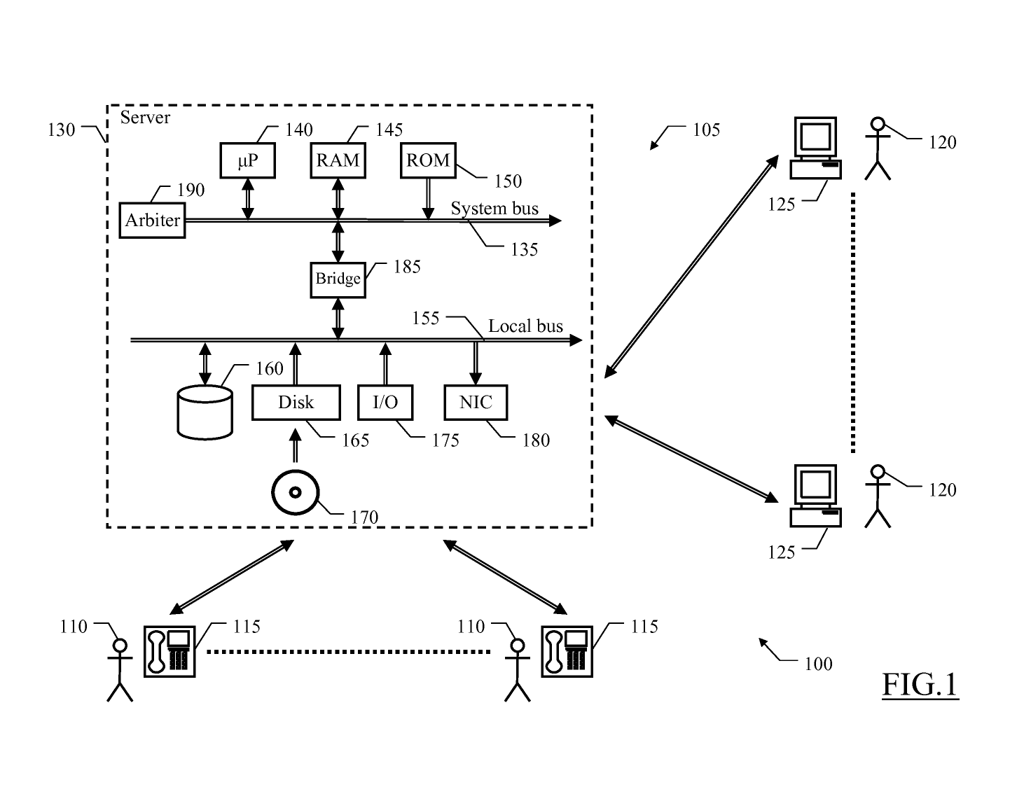

With reference in particular to the FIG. 1, an illustrative representation is shown of an infrastructure 100 wherein the solution according to the embodiment of the invention may be applied.

The infrastructure 100 is based on a support center 105 (for example, a help-desk) that provides remote support in respect of one or more products (for example, software programs). Users 110 of the products (for example, customers) submit support requests to the support center 105 for any issues relating to these products (for example, when they have difficulties in installing them, when they need help for their configuration, when they experience problems with their use, and the like); for this purpose, the users 110 may call a tool-free number of the support center 105 with their telephones 115. Each support request is captured by the support center 105 with the opening of a corresponding ticket, which comprises a logical structure used to track the serving of the support request. The tickets are allocated to agents 120 (for example, customer care operators, software engineers, software analysts). Each agent 120 serves the tickets allocated thereto by addressing their issues (for example, trying to solve the corresponding problems by working on a dedicated computer 125); once the issue of each ticket has been completely addressed (for example, by solving its problem) the agent 120 closes the ticket, and a corresponding response is returned to the user 110 by the support center 105.

Operation of the support center 105 is controlled by a data processing system, for example, a server computer (or simply server) 130. The server 130 comprises several units that are connected in parallel to a system bus 135. In detail, one or more microprocessors (μP) 140 control operation of the server 130; a RAM 145 is used as a working memory by the microprocessors 140, and a ROM 150 stores basic code for a bootstrap of the server 130. Several peripheral units are further clustered around a local bus 155 (by means of respective interfaces). Particularly, a mass memory comprises one or more hard-disks 160 and drives 165 for reading/writing optical disks 170 (for example, CDs or DVDs). Moreover, the server 130 comprises input /output (I/O) units 175 (for example, a keyboard, a mouse, a monitor, USB ports); moreover, the input/output units 175 may comprise a Computer Telephony Integration (CTI) device managing interactions between the telephones 115 of the users 110 and the server 130. A network interface card (NIC) 180 is used to connect the server 130 to a network (not shown in the figure), and particularly to the computers 125 of the agents 120; the NIC 180 may also be used by the server 130 to access the Internet, for communicating with either the users 110 or the agents 120. A bridge unit 185 interfaces the system bus 135 with the local bus 155. Each microprocessor 140 and the bridge unit 185 may operate as master agents requesting an access to the system bus 135 for transmitting information. An arbiter 190 manages the granting of the access with mutual exclusion to the system bus 135.

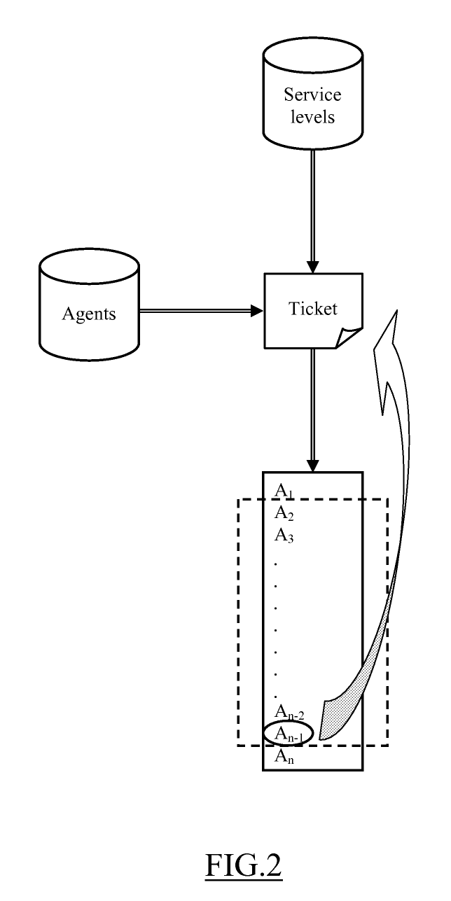

An example of application of the solution according to the embodiment of the invention is shown in the FIG. 2.

Any ticket that is opened for a corresponding user is associated with a service level thereof, which should be met in serving the ticket (for example, as defined in a SLA of the user). A set of candidate agents that are adapted to serve the ticket are determined among all the agents of the support center—for example, the agents having the required skills, denoted with A₁, A₂, A₃ . . . Aₙ₋₂, Aₙ₋₁, Aₙ in the figure. In the solution according to an embodiment of the invention, the candidate agents are ranked according to their reputation—for example, as defined by a reputation index increasing with it (from the lowest value of the agent Aₙ to the highest value of the agent A₁). The agent that is adapted to meet the service level of the ticket (i.e., any agents A₂, A₃ . . . Aₙ₋₂, Aₙ₋₁ in the figure) with the lowest reputation (i.e., the agent Aₙ₋₁ in the figure) is selected for serving the ticket. The ticket is then allocated to this selected agent Aₙ₋₁.

The solution described above is very complete and precise for meeting the service levels of the tickets; this solution is inherently efficient in this respect, since it always tries to select the candidate agent that allows meeting the required service level.

It should be noted that the selected agent is only the one that best fits the service level of the ticket, but generally not the best one in absolute terms. In this way, better agents are preserved for other tickets that may have more restrictive requirements (i.e., more stringent service levels)—such as for more severe issues or more important users.

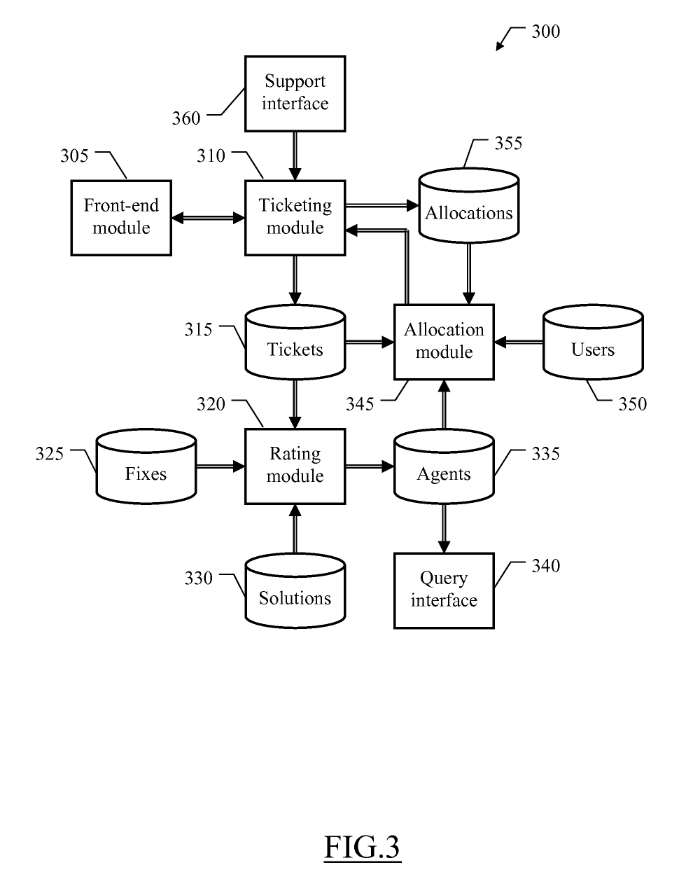

The main software modules that may be used to implement the solution according to an embodiment of the invention are shown in the FIG. 3. These software components are denoted as a whole with the reference 300. The information (programs and data) is typically stored in the hard-disk and loaded (at least partially) into the working memory of the server of the support center when the programs are running, together with an operating system and other application programs (not shown in the figure). The programs are initially installed onto the hard disk, for example, from optical disks.

Particularly, a front-end module 305 is exploited by the users to submit support requests for issues relating to the supported products. For example, the front-end module 305 may comprise a CTI interface for interacting with the users; particularly, the CTI interface manages the queuing of the incoming telephone calls from the users, the collection of information about the support requests (for example, by means of an Interactive Voice Response (IVR) system wherein the users interact with the CTI interface through the use of synthesized voice and telephone keypad or speech recognition), and automatically distributes the telephone calls to the selected agents. In addition or in alternative, the front-end module 305 may comprise a web service that allows the users to submit the support requests via the Internet (by filling corresponding web pages), and/or a mail agent that allows the users to submit the support requests via e-mail.

The front-end module 305 interfaces with a ticketing module 310, which manages all the tickets. For this purpose, the ticketing module 310 controls a repository 315 storing information about the tickets. Particularly, each ticket is identified by a (unique) ticket number, and it comprises information about the corresponding issue; typically, this information identifies a type of the ticket (for example, the affected product and a macro-function thereof), and provides a specification of its issue. Moreover, the ticket comprises an identifier of the user that submitted the corresponding support request. The ticket may also comprise a severity indicator of its issue (for example, a simple flag that is deasserted for a normal issue and it is asserted for a critical issue). In addition, the ticket comprises information about its history, such as opening time, allocated agent, outcome (i.e., positive or negative), closing time, and feedback.

A rating module 320 manages the rating of the agents. For this purpose, the rating module 320 accesses the repository of the tickets 315. Moreover, the rating module 320 accesses a repository 325 storing information about fixes that have been provided to defects (or bugs) of the supported products, comprising the name of the agents that have done so. The rating agent 320 also accesses a repository 330 storing information about solutions that have been published on problems of the supported products, comprising the name of the agents that have done so (for example, in forums and white papers). The rating module 320 extracts information relating to each agent from the repository of the tickets 315 (i.e., closed tickets assigned thereto), the repository of the fixes 325 (i.e., fixes provided by him/her) and the repository of the solutions 330 (i.e., solutions published by him/her). The rating module 320 calculates characteristic information of each agent accordingly, and stores it into a corresponding repository 335. For example, the characteristic information may comprise an average serving time for serving the tickets of normal issues and an average serving time for serving the tickets of critical issues, a number of normal issues being solved and a number of critical issues being solved (i.e., corresponding tickets with positive outcomes), a number of positive feedbacks and a number of negative feedbacks, a number of fixes provided to defects of the supported products, a number of forum posts published on problems of the supported products and a number of white-papers published on problems of the supported products (based on the extracted information); moreover, the characteristic information may comprise a reputation index (measuring a reputation of the agent), which is calculated from the above-mentioned information. In this way, the reputations of the agents may be measured objectively; in any case, the reputation indexes are based on tangible metrics that make them very accurate. A query interface 340 is used to maintain further characteristic information of each agent; for example, the query interface 340 may be used by supervisors of the agents to define the types of issues that the agents reporting thereto are adapted to address; for example, the agents may be organized into teams each one for a corresponding product, with groups within the team for different macro-functions thereof (for example, installation, user-interface, connectivity, source code, and the like). The query interface 340 may also be used to extract selected characteristic information of specific agents from the repository 335 (for example, by each agent for his/her characteristic information and by each supervisor for the characteristic information of the agents reporting thereto). This additional feature allows each agent to monitor his/her reputation and possible areas of intervention for improving it; moreover, it facilitates the management of the agents reporting to each supervisor.

An allocation module 345 manages the allocation of the agents to each new ticket that has been opened. For this purpose, the allocation module 345 accesses the repository of the tickets 315 and the repository of the agents 335. Moreover, the allocation module 345 accesses a repository 350 storing information about a service level to be meet for every user; the service level may be specified by one or more target metrics defined formally in a corresponding SLA; for example, the SLA may indicates that the support level is of a specific quality (such as golden, silver or basic), each one defining different values of the target metrics (for example, a maximum response time for addressing each normal issue and a maximum response time for addressing each critical issue). The allocation module 345 also accesses a repository 355 storing information about a current allocation of each agent (for example, his/her availability and the progress of the serving of the tickets allocated thereto). The allocation module 345 returns the selected agent for each new ticket to the ticketing module 310; the ticketing module 310 enforces the allocation of each new ticket to the corresponding selected agent, and updates the repository of the allocations 355 accordingly.

A support interface 360 further interacts with the ticketing module 310. The support interface 360 is used by every agent to retrieve information about the tickets allocated thereto (extracted from the corresponding repository 315 by the ticketing module 310); moreover, the support interface 360 is used by every agent to enter information about the progress of the serving of the tickets allocated thereto (for example, their outcomes). The support interface 360 may also be used to enter a feedback for each ticket that has been closed (for example, by the supervisor of the corresponding agent); likewise, the front-end module 305 may be used to enter a further feedback for each ticket that has been closed by the corresponding user.

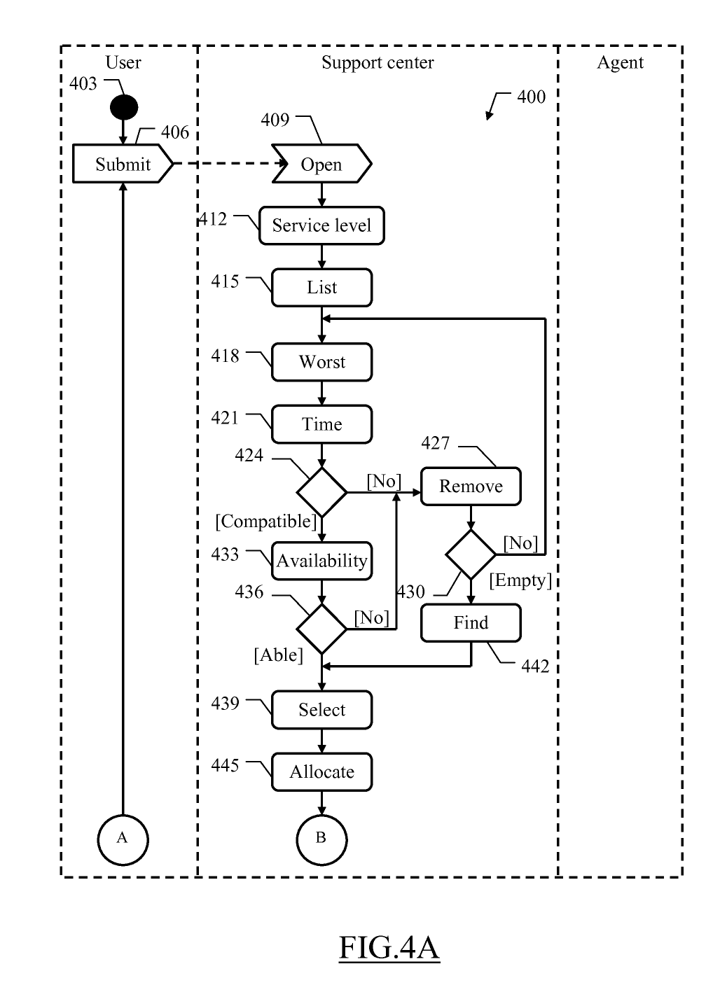

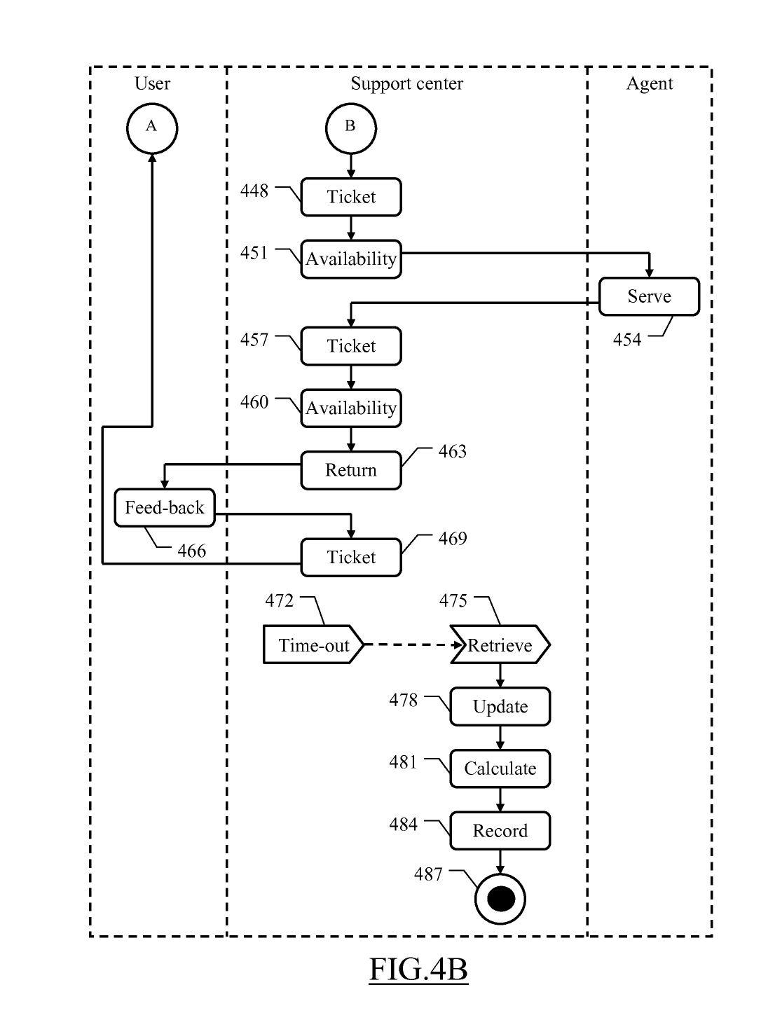

An activity diagram describing the flow of activities relating to an implementation of the solution according to an embodiment of the invention is shown in the FIG. 4A-FIG. 4B. In this respect, each block in the diagram may represent a module, segment or portion of code, which comprises one or more executable instructions for implementing the specified logical function (or more).

Particularly, the diagram represents an exemplary process that may be used to manage the support requests with a method 400. The method begins at the black start circle 403 and then passes to block 406 in the swim-lane of a generic user when a new support request is submitted to the support center. For example, the user is guided through a menu of the CTI interface to authenticate himself/herself (for example, by means of a pair identifier/password), to select the type of the issue, to enter the specification thereof (for example, its software/hardware environment and description), and to select its severity indicator (i.e., normal or critical). In response thereto (assuming that the issue is real and not just perceived, and it is not trivial) a corresponding ticket is opened at block 409 in the swim-lane of the support center. For this purpose, its unique ticket number is generated (for example, by means of an auto-increment function), and its opening time is set according to the current time; the ticket is then associated with its user identifier, type, specification and severity indicator.

Continuing to block 412, the relevant portion of the service level of the user of the ticket is retrieved (for example, the maximum response time corresponding to its severity indicator). A list of the candidate agents adapted to serve the ticket is determined at block 415; for example, each agent is set as candidate agent when s/he is adapted to serve the type of the ticket (as indicated by his/her characteristic information). The candidate agents are arranged in the list in decreasing order of their reputation index (i.e., from the best one to the worst one).

With reference now to block 418, the worst candidate agent (i.e., the last one with the lowest reputation index) is selected in the list. The average serving time of the worst candidate agent for serving the normal or critical issues (according to the severity indicator of the ticket) is retrieved at block 421. A test is then performed at block 424 to verify whether the average serving time of the worst candidate agent is compatible with the service level of the ticket (for example, when it is lower than the maximum response time corresponding to its severity indicator). If not, the worst candidate agent is removed from the list at block 427. A further test is performed at block 430 to verify the number of candidate agents remaining in the list. If the list is not empty, the method returns to the block 418 to repeat the same operations for a next worst candidate agent of the list.

Referring back to the block 424, if the average serving time of the worst candidate agent is compatible with the service level of the ticket the flow of activity descends into block 433; in this phase, the availability of the worst candidate agent is retrieved. A test is then performed at block 436 to verify whether the worst candidate agent is actually capable to serve the ticket meeting the corresponding service level according to his/her availability. For example, it is possible to increase the average serving time of the worst candidate agent according to the time that s/he is expected to spend for serving other tickets already allocated thereto, and then according to the time that s/he is planning to be absent during the period that should be spent for serving the current ticket; this updated average serving time is compared with the same maximum response time. If the worst candidate agent is not capable to serve the ticket meeting its service level, the method returns to the block 427 - so that the worst candidate agent is removed from the list and the same operations are repeated for a next worst candidate agent of the list (if it is not empty).

Conversely, if the worst candidate agent is capable to serve the ticket meeting its service level, the method descends from the block 436 into block 439; in this phase, the worst candidate agent is selected for serving the ticket. Referring back to the block 430, if the list of candidate agents is empty, the method passes to block 442. In this phase, same measures may be taken (either automatically or manually) in an attempt to find a candidate agent adapted (according to his/her characteristic information) and capable (according to his/her availability) to serve the ticket meeting its service level; for example, it is possible to suspend the serving of other tickets with lower severity and/or from less important users (so as to release agents to be allocated to the current ticket). In any case, an agent is proposed for serving the issue (even if s/he is not capable to meet the corresponding service level—for example, simply consisting of the best one in the list of candidate agents). The method then continues to the block 439, wherein this proposed agent is selected for serving the ticket as above.

The method then descends from the block 439 into block 445, wherein the selected agent is allocated to the ticket. The allocation of the selected agent to the ticket is then recorded at block 448. With reference now to block 451, the availability of the selected agent is updated accordingly.

The method then proceeds to block 454 in the swim-lane of the selected agent, wherein the ticket is served. As soon as the serving of the ticket has been completed, the flow of activity passes to block 457 in the swim-lane of the support center wherein the ticket is closed; at the same time, the closing time of the ticket is set to the current time and its outcome (as returned by the selected agent) is recorded. With reference now to block 460, the availability of the selected agent is updated accordingly. The outcome of the ticket is then returned to the corresponding user at block 463. Moving now to the swim-lane of the user at block 466, s/he enters a feedback of the ticket (for example, positive or negative). Returning to the swim-lane of the support center, the feedback of the ticket is recorded at block 469 (with the same operations that are performed when additional feedbacks are provided, for example, by the supervisor of the selected agent). The method then returns to the block 406 waiting for the submission of a further support request.

In a completely asynchronous way, the method passes from block 472 to block 475 as soon as a time-out expires (for example, very night). A loop is now performed for each agent (starting from the first one); the loop begins by retrieving information for the (current) agent about the corresponding closed tickets, provided fixes and published solutions. Continuing to block 478, the characteristic information of the agent is updated accordingly. For example, it is possible to re-calculate the average serving time of normal issues and the average serving time of critical issues according to the time elapsed between the closing time and the opening time of the corresponding tickets, the number of solved normal issues per time unit and the number of solved critical issues per time unit by counting the corresponding tickets and then dividing their count by the number of time units (for example, weeks), the number of positive feedbacks and the number of negative feedbacks, the number of provided fixes, the number of published posts, and the number of published white-papers (all of them in a pre-defined timeframe, for example, a last year). With reference now to block 481, the reputation index of the agent is calculated according to his/her characteristic information. For example, the reputation index (Ip) may be defined by the following formula:

Ip=SF·Iy,

wherein SF is a scale factor and Iy is a yield index. In turn, the yield index Iy is equal to:

Iy=(K_{Nn}·Nn/K_{Tn}·Tn)+(K_{Nc}·Nc/K_{Tc}·Tc)+((K_{Fp}·Fp+K_{Nf}·Nf−K_{Fn}·Fn)/TF)

and the scale factor SF is equal to:

SF=K_{SF}·((K_{Np}·Nₚ+K_{Nx}·Nw)/TF),

wherein:

Nn: number of solved normal issues per time unit,

Tn: average serving time of normal issues,

Nc: number of solved critical issues per time unit,

Tc: average serving time of critical issues,

Fp: number of positive feedbacks in the timeframe,

Nf: number of fixes in the timeframe,

Fn: number of negative feedbacks in the timeframe,

Np: number of posts in the timeframe,

Nw: number of white-papers in the timeframe,

TF: timeframe, and

K_{Nn},K_{Tn},K_{Nc},K_{Tc},K_{Fp},K_{Nf},K_{Nf},K_{Np},K_{Nx}: weighting factors.

The weighting factors K_{Nn},K_{Tn},K_{Nc},K_{Tc},K_{Fp},K_{Nf},K_{Nf},K_{Np},K_{Nx} are values that may be customized (for example, between 0 and 1) according to the importance to be given to the corresponding elements in the definition of the reputation index Ip. The above-described formula correlates parameters that are usually completely unrelated one to another (and that are retrieved from independent sources). The reputation index so calculated is recorded at block 484 (replacing its previous value). The method then ends at the concentric white/black stop circles 487.

Naturally, in order to satisfy local and specific requirements, a person skilled in the art may apply to the solution described above many logical and/or physical modifications and alterations. More specifically, although this solution has been described with a certain degree of particularity with reference to one or more embodiments thereof, it should be understood that various omissions, substitutions and changes in the form and details as well as other embodiments are possible. Particularly, different embodiments of the invention may even be practiced without the specific details (such as the numerical values) set forth in the preceding description to provide a more thorough understanding thereof; conversely, well-known features may have been omitted or simplified in order not to obscure the description with unnecessary particulars. Moreover, it is expressly intended that specific elements and/or method steps described in connection with any embodiment of the disclosed solution may be incorporated in any other embodiment as a matter of general design choice. In any case, ordinal or other qualifiers are merely used as labels to distinguish elements with the same name but do not by themselves connote any priority, precedence or order. Moreover, the terms include, comprise, have, contain and involve (and any forms thereof) should be intended with an open, non-exhaustive meaning (i.e., not limited to the recited items), the terms based on, dependent on, according to, function of (and any forms thereof) should be intended as a non-exclusive relationship (i.e., with possible further variable involved), and the term a/an should be intended as one or more items (unless expressly indicated otherwise).

For example, an embodiment of the present invention provides a method for controlling a support center providing support in respect of a set of (one or more) products. The method comprises the following steps under the control of a data processing system. Support requests, each one for at least one of the products, are received from users. A service level is associated with each support request according to service level information of the corresponding user stored in the data processing system. A list of (one or more) candidate agents adapted to serve each support request is determined among a plurality of agents of the support center according to characteristic information of the agents stored in the data processing system; the candidate agents are ordered according to a reputation indicator thereof calculated from the corresponding characteristic information. A selected agent is selected for each support request among the corresponding candidate agents; the selected agent is adapted to meet the service level of the support request with the lowest reputation indicated by the reputation indicator thereof. Each support request is then allocated to the corresponding selected agent.

However, the method may be applied in any other type of support center (for example, a call center, a customer support center, an in-house service) supporting any type and number of products (for example, software, hardware, services or combinations thereof). The steps of the method may be performed under the control of any other data processing system (see below). The support requests may be of any type (for example, relating to problems or questions before, during or after purchasing the products), and they may be submitted in any other way (for example, via SMS or automatically from exception handling routines) by any other type of users (for example, internal employees). The service level may be of any other type (for example, an informal agreement between internal departments) and it may be defined in any other way (for example, by average values or percentages within a definite range of values). The agents may be of any type (for example, with marketing skills), in any number and at any locations (even remote from the support center). The list of candidate agents, their reputation indicators and the selected agent may be determined in any other way (see below).

In an embodiment of the invention, the method further comprises the step of recording an availability of each agent; for each support request the step of selecting a selected agent comprises verifying whether the selected agent is capable to meet the service level of the support request according to the availability thereof.

However, the availability of each agent may be record in any other way (for example, by reading his/her calendar) and the corresponding verification may be performed in any other way (for example, according to his/her estimated yield). In any case, a basic implementation wherein each agent is simply treated as available or busy (and then comprised in or excluded from the list of candidate agents directly, respectively) is feasible.

In an embodiment of the invention, for each support request the step of selecting a selected agent comprises verifying whether a time for serving the support request by the selected agent, which is estimated according to the characteristic information and the availability thereof, is compatible with the service level of the support request.

However, the compatibly of this estimated time with the service level may be defined in any other way (for example, when it falls within a predefined percentage of an acceptable value); in any case, the meeting of the service level may be defined according to additional or alternative criteria, even non-time based (for example, a percentage of abandoned support requests, a percentage of support requests solved without any callback).

In an embodiment of the invention, for each support request the step of selecting a selected agent comprises the following operations. Any worst one of the candidate agents with the lowest reputation is discarded when the worst candidate agent is not adapted to meet the service level of the support request according to the characteristic information thereof, until the worst candidate agent is adapted to meet the service level of the support request. Any worst candidate agent is then discarded when the worst candidate agent is not capable to meet the service level of the support request according to the availability thereof until the worst candidate agent is capable to meet the service level of the support request. The worst candidate agent is then selected.

However, any other algorithm may be used for determining the selected agent (for example, discarding the worst agents by simply flagging them in the list, or even already limiting the list of candidate agents accordingly when it is created).

In an embodiment of the invention, the characteristic information of each agent comprises an indication of a set of types of support requests the agent is adapted to serve; for each support request, the step of determining a list of candidate agents comprises verifying whether each agent is adapted to serve the type of the support request according to the characteristic information thereof.

However, the type of support requests may be defined in any other way (for example, according to areas of competence such as configurations, networks, applications, security); in any case, the same method may also be applied in a support center wherein all the agents are adapted to serve every support request (so that the list of candidate agents always comprises all of them).

In an embodiment of the invention, the method further comprises the steps of tracking the serving of each support request, and updating the characteristic information of each agent according to the tracking of the serving of the support requests allocated thereto.

However, the serving of the support request may be tracked in any way and the characteristic information may be updated accordingly in any way (see below); in any case, the characteristic information may be defined in additional or alternative ways (even independently of the serving of the support requests).

In an embodiment of the invention, the step of tracking the serving of each support request comprises registering a serving time being spent for serving each support request; the step of updating the characteristic information of each agent comprises updating an average serving time of the agent according to the serving times of the support requests allocated to the agent.

However, the service time may be defined in any other way (for example, according to the time actually spent by the agent working on the support request); moreover, this value may be used to update the characteristic information in any other way (for example, by calculating whatever statistical indicators such as maximum value, minimum value, mode, median, standard deviation).

In an embodiment of the invention, the step of tracking the serving of each support request comprises registering an outcome of each support request; the step of updating the characteristic information of each agent comprises updating a solved number of support requests being solved by the agent according to the outcomes of the support requests allocated to the agent.

However, the outcome may be defined in any other way (for example, along a numerical scale); moreover, this value may be used to update the characteristic information in any other way (for example, by only taking into account the support requests with an outcome above a threshold value).

In an embodiment of the invention, the method further comprises associating a severity indicator with each support request; the step of updating the characteristic information of each agent comprises updating a specific average serving time for each severity indicator according to the serving times of the corresponding support requests allocated to the agent and/or a specific solved number for each severity indicator according to the outcomes of the corresponding support requests allocated to the agent.

However, the severity indicators may be defined in any other way (for example, along a numerical scale); moreover, specific metrics may be defined only for the average serving time, only for the solved number, or even for none of them.

In an embodiment of the invention, the step of tracking the serving of each support request comprises registering a feedback of the serving of each support request; the step of updating the characteristic information of each agent comprises updating a number of positive feedbacks and a number of negative feedbacks according to the feedbacks of the support requests allocated to the agent.

However, the feedbacks may be defined in any other way (for example, along a numerical scale), only by the users or only by the supervisors of the agents; moreover, these values may be used to update the characteristic information in any other way (for example, by discarding the best and the worst feedbacks, by only taking into account the positive feedbacks or the negative feedbacks).

In an embodiment of the invention, the method further comprises the step of updating the characteristic information of each agent according to a number of fixes provided by the agent to defects of the products.

However, this information may be used to update the characteristic information in any other way (for example, by weighting the fixes according to their complexity, time spent to provide them, actual contributions of the agent).

In an embodiment of the invention, the method further comprises the step of updating the characteristic information of each agent according to a number of solutions published by the agent on problems of the products.

However, this information may be used to update the characteristic information in any other way (for example, by weighting the solutions according to their lengths, publication sites, actual contributions of the agent).

In any case, the reputation indicator may be defined in any other way (for example, by means of multiple indexes), according to any other piece of characteristic information, and with any other periodicity (for example, for any agent whenever information relating thereto is updated). Particularly, the reputation indicator may be based on part of the metrics described above, on alternative metrics and/or on additional metrics (which may be correlated among them in any other way). For example, it is possible to filter the information used to define the metrics according to their age, to take into account an experience of the agent, his/her education, lectures, and the like; moreover, different reputation indicators may be calculated for each ticket (for example, by taking into account specific metrics for the corresponding type, product, macro-function, severity, and the like).

Generally, similar considerations apply if the same solution is implemented with an equivalent method (by using similar steps with the same functions of more steps or portions thereof, removing some steps being non-essential, or adding further optional steps); moreover, the steps may be performed in a different order, concurrently or in an interleaved way (at least in part).

Another embodiment of the present invention provides a computer program, which comprises code means for causing a data processing system to perform the steps of the above-mentioned method when the computer program is executed on the data processing system.

Another embodiment of the present invention provides a computer program product, which comprises a non-transitory computer readable medium embodying a computer program; the computer program comprises code means directly loadable into a working memory of a data processing system thereby configuring the data processing system to perform the same method.

However, the proposed solution may be implemented as a stand-alone module, as a plug-in for the ticketing module, or even directly in the ticketing module itself; it would be readily apparent that it is also possible to deploy the same solution as a service that is accessed through a network (such as in the Internet).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in base-band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the relevant computer, as a stand-alone software package, partly on this computer and partly on a remote computer or entirely on the remote computer. In the latter scenario, the remote computer may be connected to the computer through any type of network, including a local area network (LAN) or a wide area network (WAN), or the connection may be made to an external computer (for example, through the Internet using an Internet Service Provider). Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Another embodiment of the present invention provides a system, which comprises means configured for performing the steps of the above-mentioned method.

However, the proposed method may also be carried out on a system with distributed architecture (for example, with the characteristic information of the agents that is collected on the server from remote sources). In any case, the data processing system may have another structure or may comprise similar elements (such as cache memories temporarily storing the programs or parts thereof); moreover, it is possible to replace the server with any code execution entity, either based on a physical machine or a virtual machine, or with a combination of multiple entities (such as a multi-tier architecture, a grid computing infrastructure, and the like).

Generally, similar considerations apply if the system has a different structure or comprises equivalent components, or it has other operative characteristics. In any case, every component thereof may be separated into more elements, or two or more components may be combined together into a single element; moreover, each component may be replicated to support the execution of the corresponding operations in parallel. Moreover, unless specified otherwise, any interaction between different components generally does not need to be continuous, and it may be either direct or indirect through one or more intermediaries.

1. A method, in a data processing system, for controlling a support center providing support in respect of a set of products, the method comprising:
receiving a set of support requests from a set of users, each support request in the set of support requests for at least one of the set of products, and
for each support request in the set of support requests:
associating a service level with the support request according to service level information of the corresponding user stored in the data processing system,
determining a list of candidate agents adapted to serve the support request among a plurality of agents of the support center according to characteristic information of each agent in the plurality of agents stored in the data processing system, the candidate agents being ordered according to a reputation indicator of the agent calculated from the corresponding characteristic information,
selecting a selected agent for the support request among the candidate agents, the selected agent being adapted to meet the service level of the support request with the lowest reputation indicated by the reputation indicator of the agent, and
allocating the each support request to the selected agent.

2. The method according to claim 1, further comprising:
recording an availability of each agent in the plurality of agents, and
for each support request in the set of support requests, the selecting the selected agent further comprising:
verifying whether the selected agent is capable to meet the service level of the support request according to the availability of the agent.

3. The method according to claim 2, wherein for each support request in the set of support requests the selecting the selected agent further comprises:
verifying whether a time for serving the support request by the selected agent being estimated according to the characteristic information of the agent and the availability of the agent is compatible with the service level of the support request.

4. The method according to claim 3, wherein for each support request in the set of support requests the selecting the selected agent further comprises:
discarding any candidate agent of the candidate agents with the lowest reputation when the candidate agent is not adapted to meet the service level of the support request according to the characteristic information of the agent until the candidate agent is adapted to meet the service level of the support request,
discarding any candidate agent of the candidate agents when the candidate agent is not capable to meet the service level of the support request according to the availability of the agent until the candidate agent is capable to meet the service level of the support request, and
selecting from the remaining candidate agents in the candidate agents a lowest ranked candidate agent.

5. The method according to claim 1, wherein the characteristic information of each agent its the plurality of agents comprises an indication of a set of types of support requests the agent is adapted to serve, for each support request in the set of support requests the determining the list of candidate agents further comprising:
verifying whether each agent in the plurality of agents is adapted to serve the type of the support request according to the characteristic information of the agent.

6. The method according to claim 1, further comprising:
tracking the serving of each support request in the set of support requests, and
updating the characteristic information of each agent according to the tracking of the serving of the support requests allocated to the agent.

7. The method according to claim 6, wherein the tracking the serving of each support request further comprises:
registering a serving time being spent for serving each support request allocated to the agents,
and wherein the updating the characteristic information of each agent further comprises:
updating an average serving time of the agent according to the serving times of the support requests allocated to the agent.

8. The method according to claim 7, wherein the tracking the serving of each support request further comprises:
registering an outcome of each support request allocated to the agent,
and wherein the updating the characteristic information of each agent further, comprises:
updating a solved number of support requests being solved by the agent according to the outcomes of the support requests allocated to the agent.

9. The method according to claim 8, further comprising:
associating a severity indicator with each support request in the set of support requests,
wherein the updating the characteristic information of each agent further comprising:
updating a specific average serving time for each severity indicator according to the serving times of the corresponding support requests allocated to the agent or a specific solved number for each severity indicator according to the outcomes of the corresponding support requests allocated to the agent.

10. The method according to claim 6, wherein the tracking the serving of each support request further comprises:
registering a feedback of the serving of each support request allocated to the agent,
and wherein the updating the characteristic information of each agent further comprises:
updating a number of positive feedbacks and a number of negative feedbacks according to the feedbacks of the support requests allocated to the agent.

11. The method according to claim 6, further comprising:
updating the characteristic information of each agent according to a number of fixes provided by the agent to defects of the products.

12. The method according to claim 6, further comprising:
updating the characteristic information of each agent according to a number of solutions published by the agent on problems of the products.

13. A computer program product comprising a computer readable storage medium having a computer readable program stored therein, wherein the computer readable program, when executed on a data processing system, causes the data processing system to:
receive a set of support requests from a set of users, each support request in the set of support requests for at least one of a set of products that are provided support by a support center, and
for each support request in the set of support requests:
associate a service level with the support request according to service level information of the corresponding user stored in the data processing system,
determine a list of candidate agents adapted to serve the support request among a plurality of agents of the support center according to characteristic information of each agent in the plurality of agents stored in the data processing system, the candidate agents being ordered according to a reputation indicator of the agent calculated from the corresponding characteristic information,
select a selected agent for the support request among the candidate agents, the selected agent being adapted to meet the service level of the support request with the lowest reputation indicated by the reputation indicator of the agent, and
allocate the each support request to the selected agent.

14. A system comprising:
a processor; and
a memory coupled to the processor, wherein the memory comprises instructions which, when executed by the processor, cause the processor to:
receive a set of support requests from a set of users, each support request in the set of support requests for at least one of a set of products that are provided support by a support center, and
for each support request in the set of support requests:
associate a service level with the support request according to service level information of the corresponding user stored in the data processing system,
determine a list of candidate agents adapted to serve the support request among a plurality of agents of the support center according to characteristic information of each agent in the plurality of agents stored in the data processing system, the candidate agents being ordered according to a reputation indicator of the agent calculated from the corresponding characteristic information,
select a selected agent for the support request among the candidate agents, the selected agent being adapted to meet the service level of the support request with the lowest reputation indicated by the reputation indicator of the agent, and
allocate the each support request to the selected agent.

15. The system according to claim 14, wherein the instructions further cause the processor to:
record an availability of each agent in the plurality of agents, and
for each support request in the set of support requests, the instructions to select the selected agent further causes the processor to:
verify whether the selected agent is capable to meet the service level of the support request according to the availability of the agent.

16. The system according to claim 15, wherein for each support request in the set of support requests the instructions to select the selected agent further causes the processor to:
verify whether a time for serving the support request by the selected agent being estimated according to the characteristic information of the agent and the availability of the agent is compatible with the service level of the support request.

17. The system according to claim 16, wherein for each support request in the set of support requests the instructions to select the selected agent further causes the processor to:
discard any candidate agent of the candidate agents with the lowest reputation when the candidate agent is not adapted to meet the service level of the support request according to the characteristic information of the agent until the candidate agent is adapted to meet the service level of the support request,
discard any candidate agent of the candidate agents when the candidate agent is not capable to meet the service level of the support request according to the availability of the agent until the candidate agent is capable to meet the service level of the support request, and
select from the remaining candidate agents in the candidate agents a lowest ranked candidate agent.

18. The system according to claim 14, wherein the characteristic information of each agent in the plurality of agents comprises an indication of a set of types of support requests the agent is adapted to serve, for each support request in the set of support requests the instructions to determine the list of candidate agents further causes the processor to:
verify whether each agent in the plurality of agents is adapted to serve the type of the support request according to the characteristic information of the agent.

19. The system according to claim 14, wherein the instructions further cause the processor to:
track the serving of each support request in the set of support requests, and
update the characteristic information of each agent according to the tracking of the serving of the support requests allocated to the agent.

20. The system according to claim 19, wherein the instructions to track the serving of each support request further causes the processor to:
register a serving time being spent for serving each support request allocated to the agent,
and wherein the instructions to update the characteristic information of each agent further causes the processor to:
update an average serving time of the agent according to the serving times of the support requests allocated to the agent.
